(19) United States
(12) Patent Application Publication
(10) Pub. No.: US 2014/0290505 A1
(43) Pub. Date: Oct. 2, 2014

(54) Drum Crushing Device

(71) Applicant: Michael Rudnicki, Thunder Bay (CA)

(72) Inventor: Michael Rudnicki, Thunder Bay (CA)

(21) Appl. No.: 14/228,892

(22) Filed: Mar. 28, 2014

Related U.S. Application Data
(60) Provisional application No. 61/806,021, filed on Mar. 28, 2013.

(51) Int. Cl. B30B 9/32

(52) U.S. Cl. CPC B30B 9/321
USPC 100/35; 100/290

(57) ABSTRACT

Waste objects, for example used oil barrels, are crushed using a device having a frame which supports first and second press plates so as to be movable towards one another in a crushing direction. A plurality of ball screw assemblies which are connected between the press plates each include a lead screw and a follower nut with roller elements in rolling engagement with the threads of the lead screw such that there is little or no static friction which must be overcome in order to release the press plate from the crushed object once the crushing operation is complete. A motor coupled to the ball screw assemblies applies a continuous torque throughout a full range of crushing movement of the second press plate relative to the first press plate to overcome the back pressure from the object being crushed.

This application is claims the benefit under 35 U.S.C.119(e) of U.S. provisional application Ser. No. 61/806,021, filed Mar. 28, 2013.

### FIELD OF THE INVENTION

The present invention relates to a device for crushing waste objects, for example empty steel drum receptacles, and more particularly the present invention relates to a crushing device including one or more lead screws which are actuated to crush the waste objects between first and second press plates.

### BACKGROUND

Various types of presses and crushers are known for compacting and crushing waste objects to reduce their size for subsequent ease of handling, or to reduce the amount of space occupied by the waste object if discarding. A common method of driving a press involves the use of hydraulics. Examples can be found in U.S. Pat. No. 4,284,000 by Almeda, Jr. U.S. Pat. No. 5,461,973 by Page, U.S. Pat. No. 3,938,732 by Schrimper et al, and U.S. Pat. No. 5,048,413 by Deiters. The use of hydraulics can be costly and difficult to maintain due to the requirement of a pump for pressurizing the hydraulic fluid and the complexity of valves and seals which are required.

In some instances, screws are known to provide some mechanical advantage in a pressing operation. When crushing metal objects, the objects typically have some resilience which provides a considerable back force against the press plate against the direction of crushing. Frictional engagement of the screw and the nut threaded onto the screw relative to which the screw is longitudinally displaced to produce the pressing movement is thus generally known to be essential to prevent the press plate from springing back once the motor driving the relative rotation between the screw and nut ceases to provide torque in the crushing direction. When the screw and nut are directly frictionally engaged however, the back pressure on the press plate and thus the friction between the screw and nut can be so great so that an even larger torque is required to overcome the static friction and release the crushed object from the press than the torque that was provided to crush the object.

U.S. Pat. No. 5,899,141 by Gross discloses one example of a screw press in which a screw 10 is rotated relative to a threaded nut 30. An impact wrench provides the input rotation to drive relative rotation between the screw and the nut. The screw and nut are thus required to be in frictional engagement with one another in order that the press plate does not spring back between forward impacts from the impact wrench. The press can be readily become jammed however due to the excessive static friction between the screw and nut once the object has been fully crushed. Gross recognizes the potential for seizing or binding at column 3, lines 33 through 41, but only proposes use of dissimilar metals to limit the friction, while recognizing that some degree of friction is still essential in accordance with conventional knowledge related to screw presses.

U.S. Pat. No. 3,580,167 discloses another example of a screw press in which the screw 8 acts against the nut 12 in direct frictional engagement therewith to prevent the press plate from springing back throughout the pressing operation as described above. In order to overcome the problem of binding or seizing upon completion of a pressing operation, a complex release mechanism is required to release the nut from the screw.

U.S. Pat. No. 5,669,296 by Newton discloses another example of a screw press in which a screw 24 must be rotated relative to a nut 47 in direct frictional engagement therewith in order to produce a longitudinal pressing movement. A complex mechanism is required to selectively support the nut 47 against rotation to control the amount of relative rotation between the nut 47 and the screw 24. Varying the amount of frictional engagement between the nut 47 and the screw 24 is essential to adjust the ratio force of the press and meet the object of the invention in Newton.

### SUMMARY OF THE INVENTION

According to one aspect of the invention there is provided a crushing device for crushing waste objects, the crushing device comprising:

a frame;

a first press plate and a second press plate supported on the frame so as to be movable relative to one another in a crushing direction, each press plate including a supporting surface oriented transversely to the press axis such that waste objects are arranged to be crushed between the supporting surfaces as the first and second press plates are displaced towards one another;

at least one screw assembly comprising:
a lead screw comprising an elongate shaft with external threads thereon and being supported on the frame for rotation about a respective longitudinal axis oriented generally in the crushing direction of the press plates; and
a follower nut coupled to the second press plate so as to be movable together with the second press plate relative to the first press plate in the crushing direction, the follower nut including at least one roller element in rolling engagement with the threads of the lead screw;

whereby rotation of the lead screw of said at least one screw assembly about the respective longitudinal axis in a first direction drives movement of the follower nut of said at least one screw assembly and the second press plate coupled thereto in the crushing direction towards the first press plate and rotation of the lead screw of said at least one screw assembly about the respective longitudinal axis in a second direction opposite to the first direction drives movement of the second press plate away from the first press plate.

According to a second aspect of the present invention there is provided a method of crushing waste objects, the method comprising:

a) providing a crushing device comprising:
i) a frame;
ii) a first press plate and a second press plate supported on the frame so as to be movable relative to one another in a crushing direction, each press plate including a supporting surface oriented transversely to the press axis such that waste objects are arranged to be crushed between the supporting surfaces as the first and second press plates are displaced towards one another;
iii) at least one screw assembly comprising:
   a lead screw comprising an elongate shaft with external threads thereon and being supported on the frame for rotation about a respective longitudinal axis oriented generally in the crushing direction of the press plates; and
   a follower nut coupled to the second press plate so as to be movable together with the second press plate relative to the first press plate in the crushing direction, the follower nut including at least one roller element in rolling engagement with the threads of the lead screw; and
iv) a motor arranged to drive rotation of the lead screw in a first direction about the respective longitudinal axis to drive movement of the follower nut of said at least one screw assembly and the second press plate coupled thereto in the crushing direction towards the first press plate; and

b) driving the motor to apply a continuous torque to the lead screw of said at least one screw assembly throughout a full range of crushing movement of the second press plate relative to the first press plate.

Preferably said at least one roller element comprises a plurality of roller elements which form the only positive connection in engagement between the lead screw and the follower nut. The use of roller elements on the follower nut which are in rolling engagement with the threads of the lead screw ensures there is minimal or no friction between the screw and the effective nut relative to which the screw is rotated. Accordingly there is no static friction which must be overcome in order to release the press plate from the crushed object once the crushing operation is complete. Although the lack of frictional engagement between a screw and nut in a screw press does not in itself provide a means to resist back pressure of the crushed materials, it has been discovered that the amount torque required to drive the crushing operation has been so greatly reduced, for example by a factor of 5 in some instances, that the back pressure can instead be overcome by simply providing a constant input torque to the lead screw assembly throughout the full range of the pressing operation.

When the crushing device is used with a steel drum receptacle received between the supporting surfaces of the first and second press plates, the crushing device preferably further comprises a motor arranged to drive rotation of the lead screw of said at least one screw assembly so as to be arranged to crush the steel drum receptacle by applying a continuous torque to drive rotation of the lead screw of said at least one screw assembly throughout a full range of crushing movement of the second press plate relative to the first press plate.

In the illustrated embodiment, the first press plate is fixed relative to the frame and the lead screw of said at least one screw assembly is rotatably supported on the frame so as to be fixed in a longitudinal direction of the lead screw relative to the frame.

Preferably said at least one screw assembly comprises a plurality of screw assemblies at spaced apart positions about a perimeter of the first and second press plates.

When the first and second press plates each comprise four corners so as to be generally rectangular in shape, preferably one screw assembly is operatively connected between the first and second press plates at each of the four corners.

The crushing device preferably further comprises a motor having a single rotary output and a drive transmission which couples the single rotary output of the motor to each of the lead screws of the plurality of screw assemblies so as to be arranged to simultaneously drive the plurality of screw assemblies.

When the frame includes two ends which are opposite one another in the crushing direction, preferably the drive transmission is coupled between the plurality of lead screws at one of the two ends of the frame.

Preferably a perimeter wall spans the frame in the crushing direction about a perimeter of the first and second press plates in which the perimeter wall includes an opening spanning one side of the frame so as to be arranged to receive the waste objects to be crushed therethrough.

Preferably the motor is fully received within the perimeter wall.

The plurality of screw assemblies are preferably located at spaced apart positions about the perimeter of the first and second press plates so as to be enclosed within the perimeter wall.

The crushing device may further comprise: i) a motor fully received within the perimeter wall which has a rotary output; and ii) a drive transmission which couples the rotary output of the motor to each of the lead screws of the plurality of screw assemblies so as to be arranged to simultaneously drive the plurality of screw assemblies, in which the drive transmission is located at a bottom end of the frame so as to be surrounded by the perimeter wall.

When a sleeve member surrounds the lead screw of said at least one screw assembly between the first and second press plates, preferably the sleeve member is extendible in length as the first and second press plates are displaced relative to one another in the crushing direction.

One embodiment of the invention will now be described in conjunction with the accompanying drawings in which:

### BRIEF DESCRIPTION OF THE DRAWINGS

FIG. 1 is a perspective view of the crushing device;

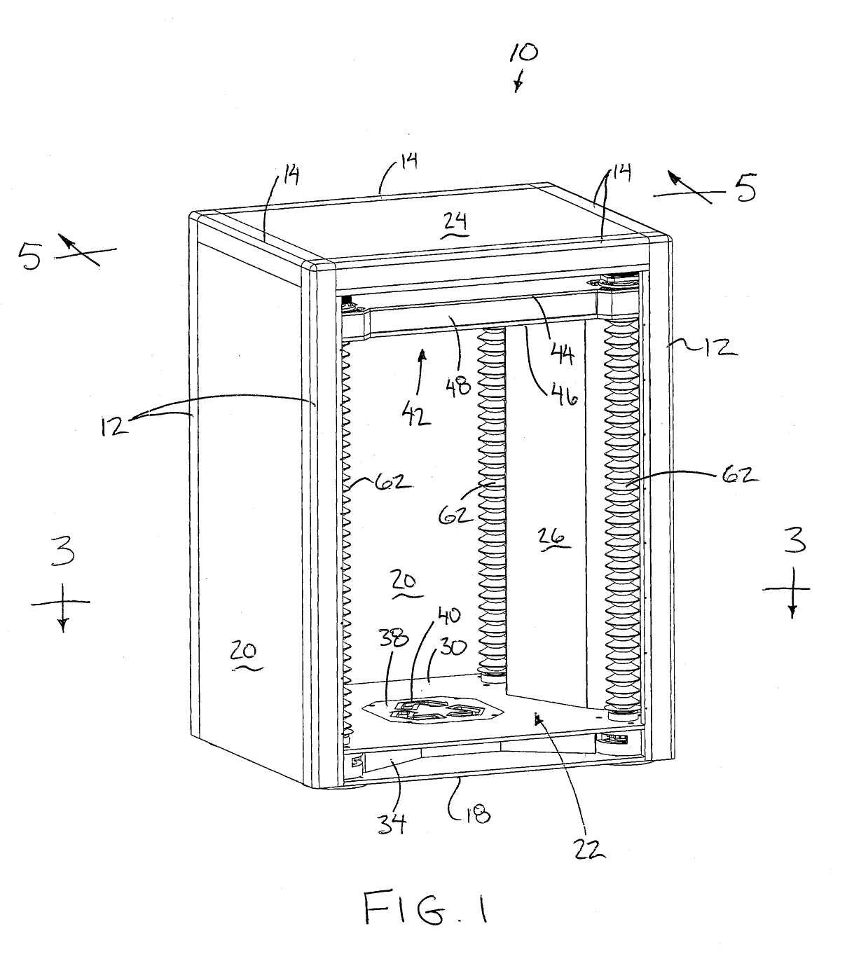

FIG. 2 is another perspective view of the crushing device in which a top wall and a side wall are shown removed;

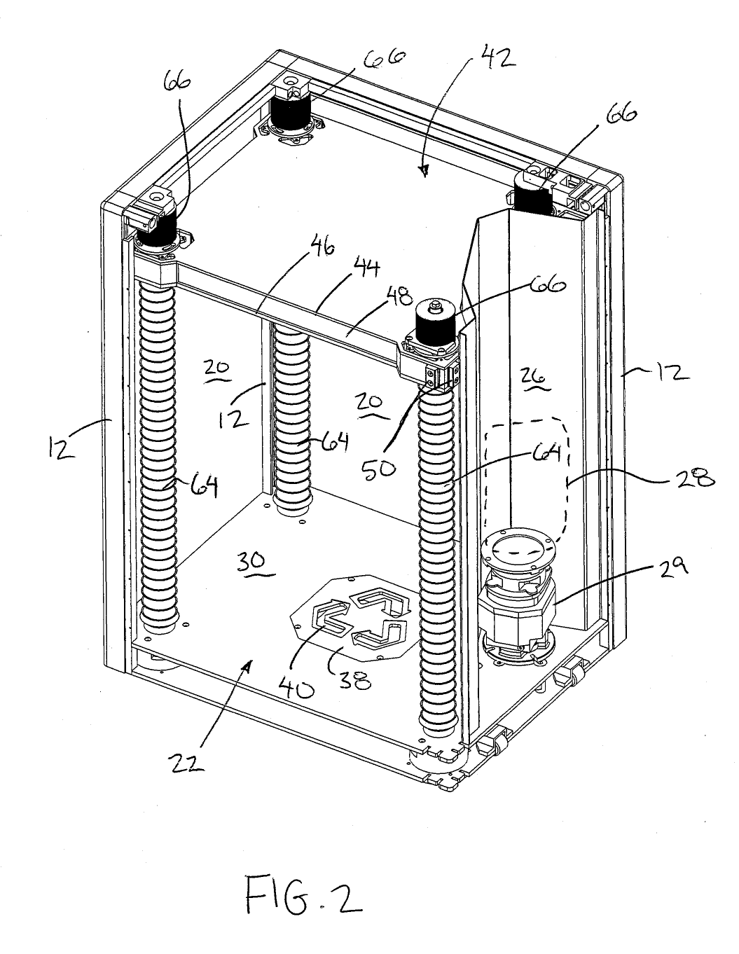

FIG. 3 is a sectional view of the crushing device along the line 3-3 of FIG. 1;

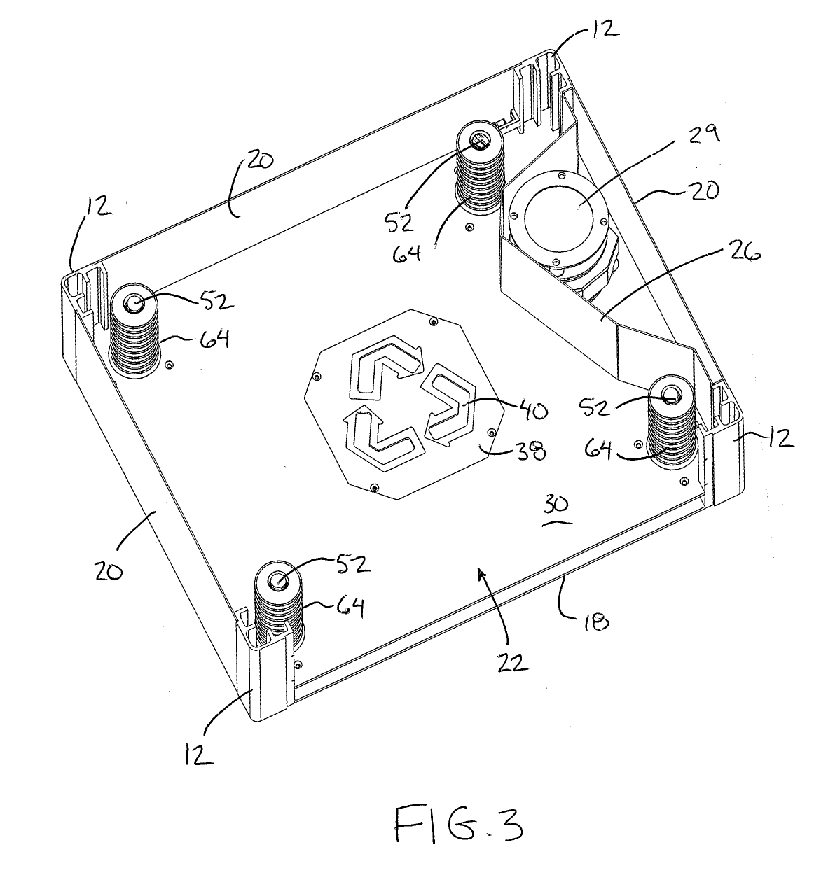

FIG. 4 is a perspective view of a bottom side of the crushing device in which a bottom wall is shown removed;

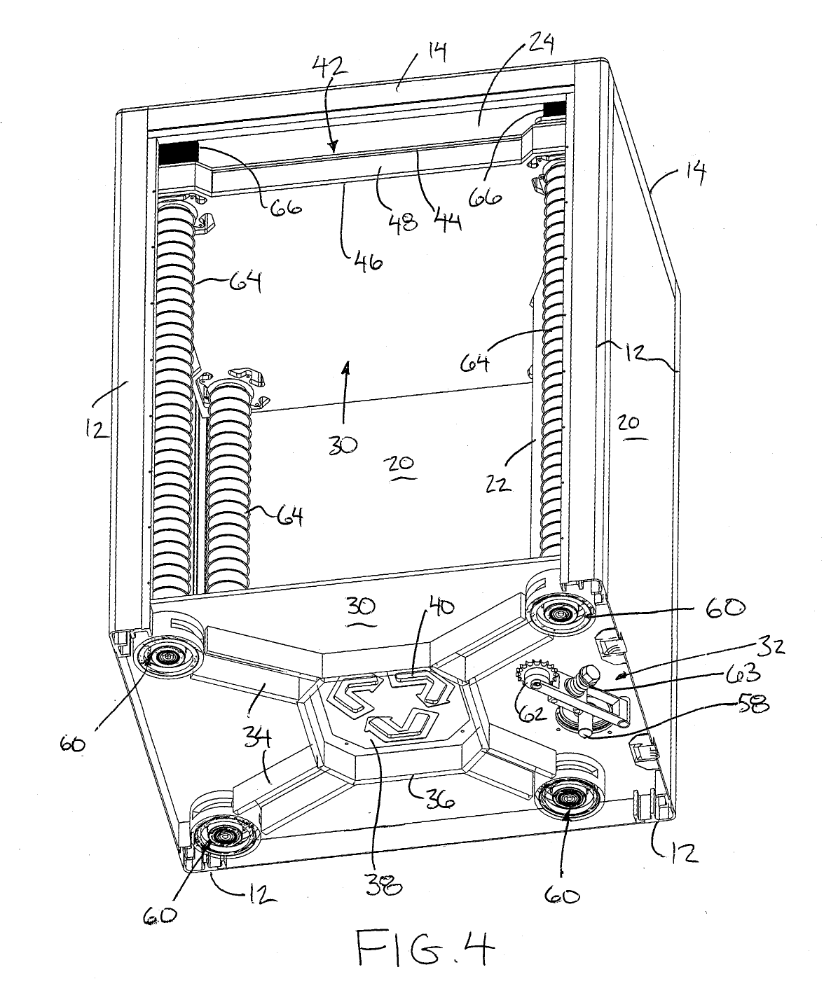

FIG. 5 is a sectional view of the crushing device along the line 5-5 of FIG. 1; and

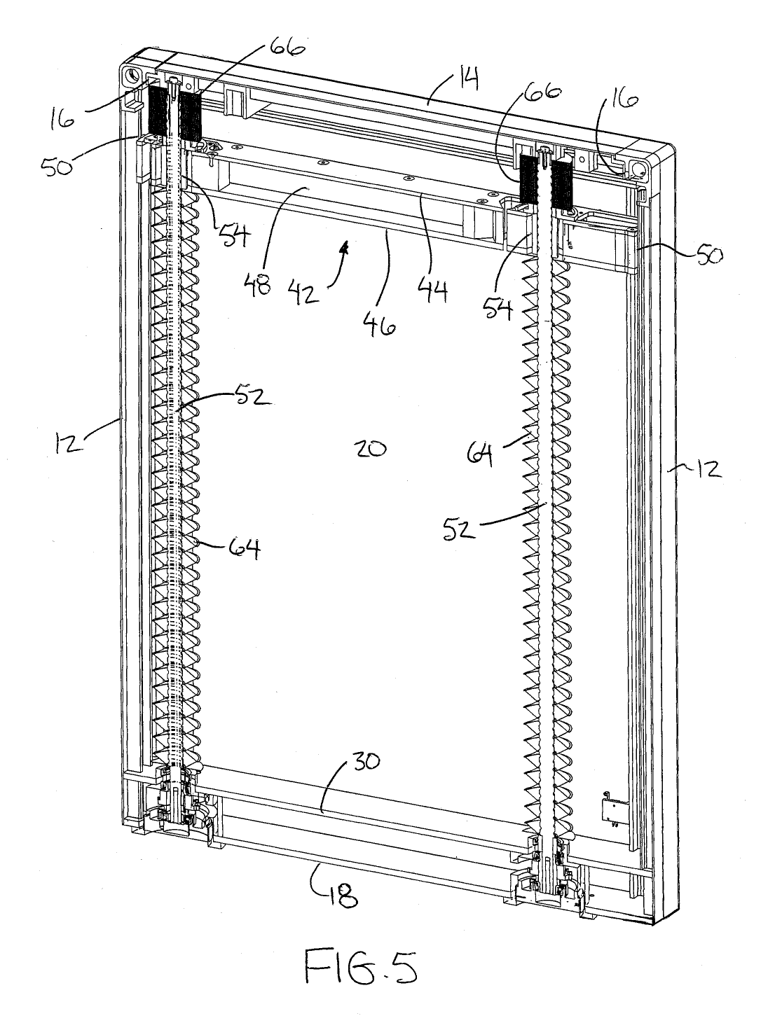

FIG. 6 is a perspective view of one of the follower nuts of one of the screw assemblies illustrating the rolling elements arranged for rolling contact with the threads of the respective screw.

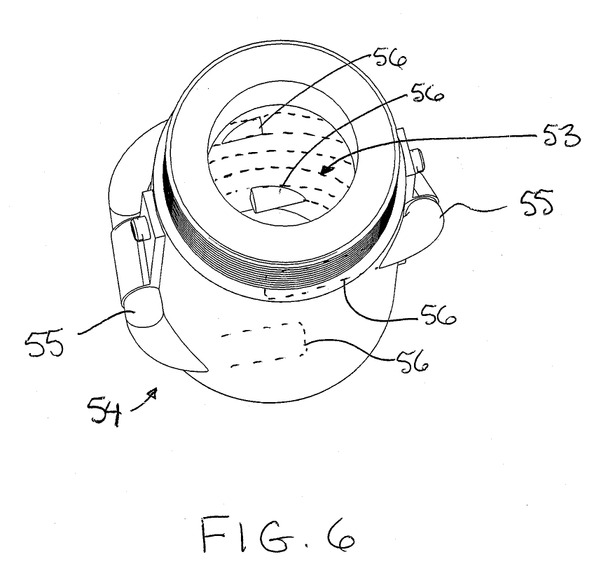

In the drawings like characters of reference indicate corresponding parts in the different figures.

### DETAILED DESCRIPTION

Referring to the accompanying figures, there is illustrated a crushing device generally indicated by reference numeral 10. The device 10 is suited for crushing various waste objects, for example empty 55 gallon steel drum receptacles.

The device includes a housing supported by a frame which includes four corner posts 12 in a rectangular relation with one another to define four corners of a rectangular shape of the housing. The four corner posts 12 are vertical and parallel to one another. Each post is joined to the adjacent posts on either side thereof by four cross bars 14 connected between the top ends of the posts such that the four cross bars define the rectangular perimeter of the housing at the top end thereof. A corner bracket 16 is provided at the top end of each post for interconnection to the two adjacent cross bars and other components as described in further detail below.

The housing further includes a bottom wall 18 which is rectangular in shape to fully span the bottom side of the housing between the four corner posts 12. The housing further includes 3 wall panels which extend vertically upward between longitudinally opposed top and bottom ends of the housing at two laterally opposed sides and a rear of the perimeter of the housing respectively. The three wall panels 20 are thus arranged in a U-shaped configuration about the perimeter of the frame. The front side 22 remains open. A top wall 24 spans the top end of the housing between the cross bars so as to substantially span the full width and depth of the housing.

The housing further includes a divider wall 26 which extends vertically upward from the bottom wall to the top wall at a location spaced inwardly from one of the wall panels 20 at one side of the housing. The divider wall 26 is joined to the adjacent corner posts at the front and rear ends while being contoured to protrude inwardly along a central portion thereof. A resulting chamber is defined between the divider wall 26 and the respective wall panel 20 at the side of the housing which spans vertically the full height of the housing to receive a motor 28 supported on a gearbox 29 therein. Operation of the motor and gearbox will be described in further detail below.

A first press plate 30 is mounted adjacent the bottom end of the housing within the interior of the perimeter wall. The first press plate fully spans the width and depth of the housing so as to be generally rectangular in shape at a location spaced slightly above the bottom wall to define a lower chamber between the first press plate and the bottom wall. The lower chamber receives a drive transmission 32 as described in further detail below.

A plurality of support elements 34 span vertically between the bottom wall and the first press plate directly thereabove in order to provide structural stiffness and support to the first press plate 30 supported thereon. The support elements include an annular portion 36 which is generally ring shaped about a central portion of the first press plate thereabove in sealing engagement with the bottom wall to form a receptacle arranged to contain fluid therein.

The upper surface of the first press plate defines a supporting surface against which the objects to be crushed are engaged during crushing. The first press plate remains fixed relative to the frame and the housing. The central portion 38 of the press plate which is aligned with the receptacle formed by the annular portion 36 comprises a removable grate including a plurality of drain openings 40 formed therein to permit collection of fluids released from objects being crushed on the first press plate.

A second press plate 42 is mounted within the interior of the housing to span generally horizontally within the perimeter wall. Accordingly the second press plate is similarly generally rectangular in shape to span between the four corners of the frame. The second press plate is vertically movable relative to the first press plate through a full range of crushing movement between a raised position adjacent the top end of the housing and a lowered position adjacent the first press plate at the bottom end of the housing. A bottom surface of the second press plate defines a second supporting surface for engaging the object to be crushed during a crushing operation. The first and second supporting surfaces of the first and second press plate respectively are thus arranged to engage opposing ends of an object to be crushed therebetween as the second press plate is driven towards the first press plate in a crushing operation.

The second press plate 42 is an assembly formed of a first plate member 44 and a second plate member 46 which are fixed relative to one another in parallel and spaced apart relationship by a plurality of supporting elements 48 spanning vertically therebetween to provide structural rigidity to the first and second plate members. The entire assembly of the first and second plate members rigidly joined together defines the second press plate which is moveable collectively relative to the first press plate in a crushing operation.

A bushing member 50 is provided at each of the four corners of the rectangular second press plate by mounting the bushing members between the first and second plate members such that the bushing members are in direct sliding engagement with respective ones of the four corner posts. The engagement of the bushing members of the four corners of the second press plate with the four corner posts respectively assists in guiding movement of the second press plate vertically relative to the first press plate in a crushing direction which is perpendicular to the orientation of the supporting surfaces.

Position of the second press plate relative to the first press plate and the driving of the crushing movement of the second press plate towards the first press plate are accomplished by a set of screw assemblies 50. In particular, four screw assemblies are provided at evenly spaced positions about the perimeter of the first and second press plates at the four corners thereof respectively at a location within the interior of the perimeter wall of the housing.

Each screw assembly includes a lead screw 52 in the form of an elongate shaft which extends vertically in a longitudinal direction of the shaft parallel to the vertical crushing direction of the movement of the second press plate. Each shaft includes external threads thereon. Each lead screw 52 is coupled at the top end to a respective one of the corner brackets 16 by a suitable bearing member adjacent the top wall for free relative rotation therebetween. Bearing support of the lead screw relative to the first press plate and the bottom wall of the housing are also provided by respective bearings to ensure that each lead screw is fixed in the longitudinal direction thereof but remains freely rotatable relative to the housing.

Each screw assembly further includes a follower nut 54 supported on the second press plate to as to be constrained between the first and second plate members of the second press plate assembly. The follower nut generally comprises a collar receiving the threaded shaft of the lead screw therethrough and having an internally threaded surface 53 which matches the threading configuration of the shaft but which is spaced outwardly therefrom. Accordingly the internal threads 53 of the follower nut 54 are not in direct threaded engagement with the external threads of the shaft of the corresponding lead screws. Instead the internal threads of the follower nut 54 only define a helical track receiving a plurality of roller elements (not shown) comprising freely rotatable frictionless ball bearings in series with one another therein. Each roller element is partially received within the threads of the follower nut 54 and partially received within the threads of the shaft of the lead screw.

All of the roller elements are thus arranged for rolling contact with both the shaft of the respective lead screw between respective threads thereof and the follower nut 54 between the respective threads thereof such that the only engagement between the lead screw and the respective follower nut is the rolling contact of the rolling elements. More particularly, the only threaded contact between the second press plate assembly and each lead screw is by the rolling contact of the roller elements.

In addition to the internal threads 53, each follower nut 54 further includes a pair of external tracks 55 in the form of tubes which communicate the ball bearings defining the roller elements externally of the collar between the opposing top and bottom ends 56 of the internal threads 53. The tubes or tracks 55 have an inner diameter closely receiving the roller elements therein. In this manner the roller elements each roll along a respective closed loop path defined by the inner threads 53 and the external tracks 55 of the respective follower nut in a continuous manner. Accordingly, the screw assemblies each function as a ball lead screw.

The four screws of the screw assemblies are arranged for rotation together by common connection to the gearbox 29 and motor 28 through the portion of the drive transmission 32 received in the lower chamber of the housing. The motor 28 and gearbox 29 are supported within the chamber defined between the divider wall 28 and the respective wall panel 20 directly above the first press plate such that a rotary output 58 of the gearbox protrudes downwardly through an aperture in the first press plate to be located within the lower chamber between first press plate and the bottom wall.

The motor comprises an electric motor arranged to apply a continuous torque in a first direction about the vertical axis of the rotary output corresponding to movement of the second press plate downward towards the first press plate in the crushing operation. The motor is also arranged to control rotation of the rotary output and the lead screws in a second direction opposite to the first direction to reverse the movement of the second press plate away from the first press plate.

Each of the four lead screws 52 includes a drive gear 60 fixed at the bottom end thereof for rotation with the screw relative to the housing. The drive gear is located within the lower chamber between the first press plate and the bottom wall of the housing in horizontal alignment with a corresponding output gear on the rotary output 58 of the motor. The drive transmission in the lower chamber of the housing further includes a drive chain interconnected between each of the drive gears 60 and the rotary output 58 of the gearbox. The drive gears have the same gear ratio relative to the motor to permit the four lead screws to be simultaneously rotated together by the same amount in either direction.

Also mounted within the lower chamber is a slack adjuster 62 comprising an idler gear mounted on a biased arm for removing slack in the chain in a conventional manner. The slack adjuster includes an adjustable overload spring 63 which permits the arm to be tripped at a prescribed tension in the chain before damage to the lead screws occurs in an overloaded condition of the pressing force applied by the motor to crush an object. In this manner, when the object being crushed can no longer be crushed, but the motor continuous to apply a crushing torque to the lead screws, the excess tension in the chain will cause the biased arm to deflect sufficiently when the prescribed overload tension is reached so that an overload switch in activated and the power to the motor is cut off before damage occurs to the screw assemblies.

Each screw assembly 50 further includes a shroud about the lead screw including a first sleeve 64 about the screw between the first and second press plates and a second sleeve 66 about the screw between the second press plate and the top wall of the housing. Each of the sleeves 64 and 66 is arranged in an accordion or bellows configuration so as to be readily adjustable and extendible in length to fully span the respective portion of the lead screw regardless of the position of the second press plate between the first press plate and the top wall of the housing.

A door may be optionally provided to fully span the open front side of the housing in a closed position of the door. The door is typically mounted by a hinge along one side of the opening to permit the door to be readily pivoted between the closed position and an open position in which the open front side of the housing is substantially unobstructed by the door.

In this manner, a waste barrel or other waste object can be readily inserted into the open front side of the housing for crushing by initially located the second press plate at the top end of the housing. Actuating the motor in the first direction then causes the screws to be rotating together in the first direction about the respective longitudinal axes thereof corresponding to the second press plate being driven downwardly towards the first press plate in the crushing direction.

Any fluid released from the object being crushed can be readily collected through the drain openings in the central portion 38 of the first press plate for collection within the receptacle defined therebelow by the annular portion of the support elements 34.

During the crushing operation, the motor is actuated to apply a continuous torque in the first direction throughout the full crushing operation. Deactivating the motor permits the motor to be readily released which in turn can permit the back pressure on the second press plate from the crushed object to urge the press plate upwardly by rolling contact of the roller elements 56 with the respective lead screws 52. Actuating the motor in the reverse direction permits the second press plate to be lifted back to the top end of the housing for ease of removal of the crushed object and to permit loading of another object to be crushed into the housing.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense

1. A crushing device for crushing waste objects, the crushing device comprising:
a frame;
a first press plate and a second press plate supported on the frame so as to be movable relative to one another in a crushing direction, each press plate including a supporting surface oriented transversely to the press axis such that waste objects are arranged to be crushed between the supporting surfaces as the first and second press plates are displaced towards one another;
at least one screw assembly comprising:
a lead screw comprising an elongate shaft with external threads thereon and being supported on the frame for rotation about a respective longitudinal axis oriented generally in the crushing direction of the press plates; and
a follower nut coupled to the second press plate so as to be movable together with the second press plate relative to the first press plate in the crushing direction, the follower nut including at least one roller element in rolling engagement with the threads of the lead screw;
whereby rotation of the lead screw of said at least one screw assembly about the respective longitudinal axis in a first direction drives movement of the follower nut of said at least one screw assembly and the second press plate coupled thereto in the crushing direction towards the first press plate and rotation of the lead screw of said at least one screw assembly about the respective longitudinal axis in a second direction opposite to the first direction drives movement of the second press plate away from the first press plate.

2. The crushing device according to claim 1 wherein said at least one roller element comprises a plurality of roller elements in rolling engagement between the lead screw and the follower nut.

3. The crushing device according to claim 1 wherein said at least one roller element comprises the only positive connection in engagement between the lead screw and the follower nut.

4. The crushing device according to claim 1 in combination with a steel drum receptacle received between the supporting surfaces of the first and second press plates, the crushing device further comprising a motor arranged to drive rotation of the lead screw of said at least one screw assembly so as to be arranged to crush the steel drum receptacle.

5. The crushing device according to claim 1 further comprising a motor arranged to apply a continuous torque to drive rotation of the lead screw of said at least one screw assembly throughout a full range of crushing movement of the second press plate relative to the first press plate.

6. The crushing device according to claim 1 wherein the first press plate is fixed relative to the frame and the lead screw of said at least one screw assembly is rotatably supported on the frame so as to be fixed in a longitudinal direction of the lead screw relative to the frame.

7. The crushing device according to claim 1 wherein said at least one screw assembly comprises a plurality of screw assemblies at spaced apart positions about a perimeter of the first and second press plates.

8. The crushing device according to claim 7 wherein the first and second press plates each comprise four corners so as to be generally rectangular in shape and wherein one screw assembly is operatively connected between the first and second press plates at each of the four corners.

9. The crushing device according to claim 1 wherein said at least one screw assembly comprises a plurality of screw assemblies and wherein the crushing device further comprises a motor having a rotary output and a drive transmission which couples the rotary output of the motor to each of the lead screws of the plurality of screw assemblies so as to be arranged to simultaneously drive the plurality of screw assemblies.

10. The crushing device according to claim 9 wherein the frame includes two ends which are opposite one another in the crushing direction and wherein the drive transmission is coupled between the plurality of lead screws at one of the two ends of the frame.

11. The crushing device according to claim 1 further comprising a perimeter wall spanning the frame in the crushing direction about a perimeter of the first and second press plates, the perimeter wall including an opening spanning one side of the frame so as to be arranged to receive the waste objects to be crushed therethrough.

12. The crushing device according to claim 11 further comprising a motor arranged to drive rotation of the lead screw of said at least one screw assembly, the motor being fully received within the perimeter wall.

13. The crushing device according to claim 11 wherein said at least one screw assembly comprises a plurality of screw assemblies at spaced apart positions about the perimeter of the first and second press plates so as to be enclosed within the perimeter wall.

14. The crushing device according to claim 11 wherein said at least one screw assembly comprises a plurality of screw assemblies and wherein the crushing device further comprises:
a motor fully received within the perimeter wall which has a rotary output; and
a drive transmission which couples the rotary output of the motor to each of the lead screws of the plurality of screw assemblies so as to be arranged to simultaneously drive the plurality of screw assemblies, the drive transmission being located at a bottom end of the frame so as to be surrounded by the perimeter wall.

15. The crushing device according to claim 1 wherein there is provided a sleeve member surrounding the lead screw of said at least one screw assembly between the first and second press plates, the sleeve member being extendible in length as the first and second press plates are displaced relative to one another in the crushing direction.

16. A method of crushing waste objects, the method comprising:
a) providing a crushing device comprising:
i) a frame;
ii) a first press plate and a second press plate supported on the frame so as to be movable relative to one another in a crushing direction, each press plate including a supporting surface oriented transversely to the press axis such that waste objects are arranged to be crushed between the supporting surfaces as the first and second press plates are displaced towards one another;
iii) at least one screw assembly comprising:
a lead screw comprising an elongate shaft with external threads thereon and being supported on the frame for rotation about a respective longitudinal axis oriented generally in the crushing direction of the press plates; and
a follower nut coupled to the second press plate so as to be movable together with the second press plate relative to the first press plate in the crushing direction, the follower nut including at least one roller element in rolling engagement with the threads of the lead screw; and
iv) a motor arranged to drive rotation of the lead screw in a first direction about the respective longitudinal axis to drive movement of the follower nut of said at least one screw assembly and the second press plate coupled thereto in the crushing direction towards the first press plate; and
b) driving the motor to apply a continuous torque to the lead screw of said at least one screw assembly throughout a full range of crushing movement of the second press plate relative to the first press plate.
